(19) United States
(12) Patent Application Publication
(10) Pub. No.: US 2020/0253408 A1
(43) Pub. Date: Aug. 13, 2020

(54) COOKING APPARATUS FOR SMOKING FOOD

(71) Applicant: Josef Dvoracek, Aurora, CO (US)

(72) Inventor: Josef Dvoracek, Aurora, CO (US)

(21) Appl. No.: 16/780,430

(22) Filed: Feb. 3, 2020

Related U.S. Application Data
(60) Provisional application No. 62/803,229, filed on Feb. 8, 2019.

(51) Int. Cl. A47J 27/00; A47J 36/06; A47J 33/00; A47J 36/02; A23L 5/10

(52) U.S. Cl. CPC A47J 27/002; A47J 36/06; A23L 5/10; A47J 36/02; A47J 33/00

(57) ABSTRACT

An apparatus for smoking food includes a pot having a floor, a sidewall extending upwardly from the floor to an upward edge, and an interior cooking region formed within the sidewall above the floor. A tube extends through the floor into the interior cooking region, forming a first opening adjacent the floor, a second opening adjacent the upward edge, and a height from the first to the second openings. A lid has a perimeter edge to engage the upward edge of the pot. The tube height and the lid location above the tube when engaged with the upward edge provides a smoke passageway from the first opening, through the second opening, into the interior cooking region. A method includes cooking food in an alternate cooking apparatus for an initial time period, after which the food is transferred to the smoking pot apparatus. Other embodiments are also disclosed.

### REFERENCE TO PENDING PRIOR PATENT APPLICATION

This application claims the benefit under 35 U.S.C. 119(e) of U.S. Provisional Patent Application No. 62/803,229, filed Feb. 8, 2019 by Josef Dvoracek for “COOKING APPARATUS FOR SMOKING FOOD,” which patent application is hereby incorporated herein by reference.

### BACKGROUND

Generally, cooking systems for smoking food require extensive tubing and/or ductwork to capture and direct smoke from a smoke source to the food being cooked. Such systems are not conducive to use with a conventional grill unless extensive apparatus is positioned around a fire source. These complexities lead to expense and difficulty in cooking food to impart a smoked flavor onto food from the fire or other smoke source.

In addition, existing cooking systems for smoking food are generally configured to smoke solid food such as meats and vegetables and are not able to effectively smoke, or impart a smoky flavor to, foods that contain a liquid component.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

One embodiment provides a cooking apparatus for smoking food. The cooking apparatus may include a pot having a floor, a sidewall extending upwardly from the floor to an upward edge, an interior cooking region formed within the sidewall and above the floor, and a tube extending through the floor of the pot into the interior cooking region, the tube forming a first opening adjacent the floor, a second opening adjacent the upward edge, and a height from the first opening to the second opening. The cooking apparatus may also include a lid having a perimeter edge to engage the upward edge of the pot, wherein the height of the tube and a location of the lid above the tube when the perimeter edge is engaged with the upward edge of the pot provides a smoke passageway from the first opening, through the second opening, and into the interior cooking region.

Another embodiment provides a cooking device for smoking food, comprising (1) a pot, including (a) a floor; (b) a sidewall extending proximally-to-distally from the floor to an upward edge such that an interior cooking region is formed within the sidewall and above the floor; and (c) a tube extending proximally-to-distally from a first opening formed in the floor to a second opening formed adjacent to the upward edge of the sidewall; and (2) a lid having a domed interior portion that terminates in a perimeter edge, wherein engaging the perimeter edge with the upward edge of the pot forms a smoke pathway from the first opening, through the second opening, and into the interior cooking region.

Yet another embodiment provides a method of smoking food with a smoking pot apparatus. The method may include the steps of cooking food in a first cooking apparatus for an initial period of time, and after the initial period of time, moving the food from the first cooking apparatus to the smoking pot apparatus, which may include (1) a pot having a floor, a sidewall extending upwardly from the floor to an upward edge, an interior cooking region formed within the sidewall and above the floor, and a tube extending through the floor into the interior cooking region, the tube having a first opening adjacent the floor, a second opening adjacent the upward edge, and a height from the first opening to the second opening; and (2) a lid having a domed interior portion extending to a perimeter edge that engages with the upward edge of the sidewall of the pot. The height of the tube and the location of the domed interior portion of the lid above the second opening of the tube when the perimeter edge of the lid is engaged with the upward edge of the pot provides a smoke pathway from the first opening, through the second opening, and into the interior cooking region.

Other embodiments are also disclosed.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 illustrates a front plan view of a novel cooking apparatus for smoking food, the apparatus having a pot and a lid;

FIG. 2 illustrates a cross-sectional view at a mid-portion of a sidewall of the pot along section 2-2′ of FIG. 1;

FIG. 3 illustrates a bottom plan view of the cooking apparatus of FIG. 1;

FIG. 4 illustrates a cross-sectional view along section 4-4′ of FIG. 3 so as to illustrate a tube extending through a floor of the pot and rising to a location near an engaged lid so as to provide an interior cooking region with a large volume in comparison to the exterior dimensions of the entire apparatus;

FIG. 5 illustrates a cross-sectional view along section 5-5′ of FIG. 3 so as to illustrate a pair of handles extending from the sidewall of the pot, as well as the tube located between the handles;

FIG. 6 illustrates a cross-sectional view of a lid of the cooking apparatus, as shown in FIGS. 1, 4, and 5;

FIG. 7 illustrates a front perspective view of another embodiment of a novel apparatus for smoking food;

FIG. 8 illustrates a side plan view of the cooking apparatus of FIG. 7;

FIG. 9 illustrates a rear perspective view of the cooking apparatus of FIG. 7;

FIG. 10 illustrates a front perspective view of another embodiment of a novel apparatus for smoking food;

FIG. 11 illustrates a side plan view of the cooking apparatus of FIG. 10;

FIG. 12 illustrates a rear perspective view of the cooking apparatus of FIG. 10; and

FIG. 13 provides a flowchart depicting an exemplary method of preparing solid or liquid food using an embodiment of the cooking apparatus for smoking food, as shown in FIGS. 1-12.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

Embodiments of the device disclosed herein provide a cooking apparatus or device for smoking food. Embodiments of the cooking apparatus feature an elegant design that does not require extensive tubing or ductwork, either internal or external to the apparatus, in order to capture smoke from a smoke source and direct it to liquid or solid food being cooked within the cooking apparatus. As a result, embodiments of the disclosed cooking apparatus are simple and intuitive to use, sufficiently robust to withstand decades of use, easily and conveniently cleaned and stored between uses, and portable. In addition, and unlike existing smoking devices, embodiments of the cooking apparatus may be used to smoke or to impart a smoky flavor to both liquid foods (with or without solids) and solid foods including meats, vegetables, fruits, stews, soups, broths, and so on.

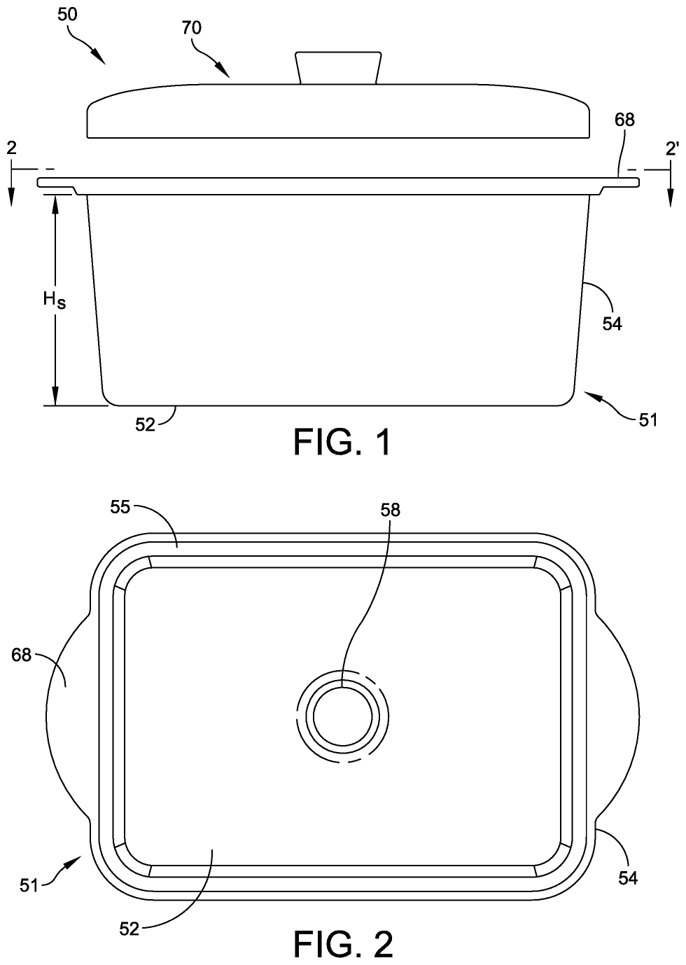

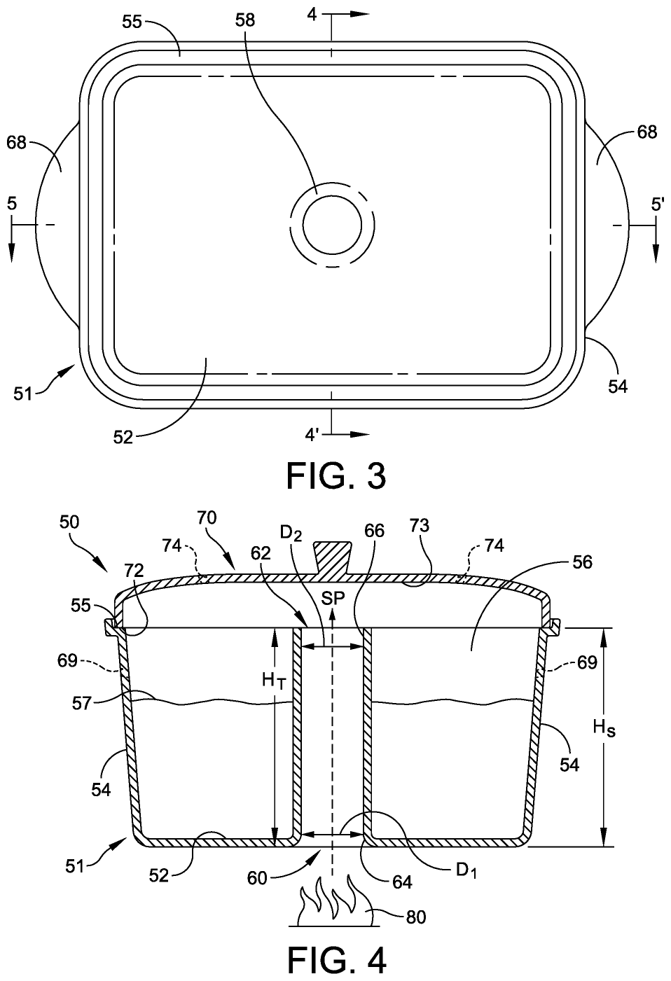

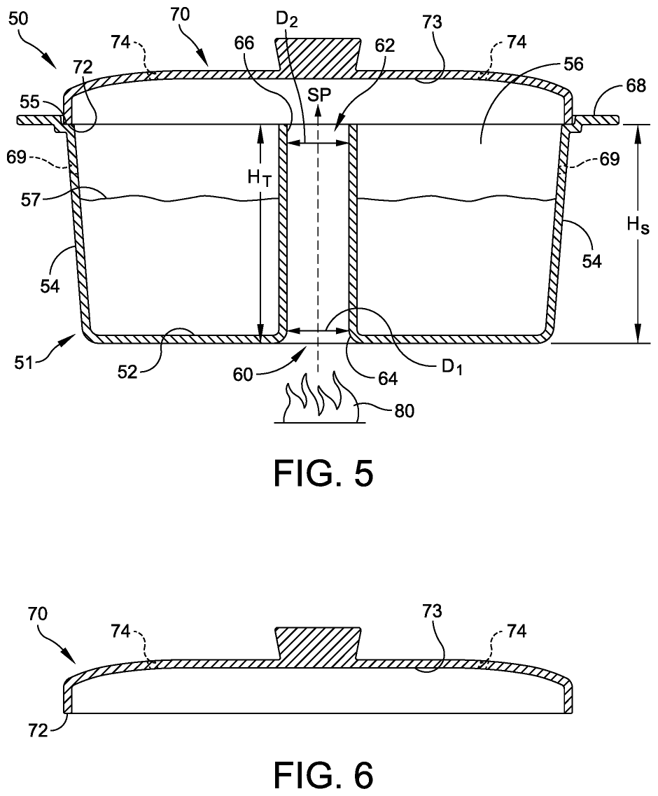

Turning to exemplary embodiments shown in the figures, FIG. 1 provides a side-plan view of one embodiment of a novel cooking apparatus 50 for smoking food. FIG. 2 illustrates a cross-sectional view of the apparatus 50 along section 2-2′. FIG. 3 illustrates a bottom plan view of the cooking apparatus 50, while FIGS. 4-5 illustrate cross-sectional views along sections 4-4′ and 5-5′, respectively.

In this embodiment, the cooking apparatus 50 may include a pot 51 having a floor 52, from which a sidewall 54 extends upwardly to an upward edge 55 positioned at a sidewall height, H_{S}, above the floor 52. The floor 52 and the sidewall 54 may combine to define an interior cooking region 56 that is bounded by the floor 52, the sidewall 54, and a lid 70 having a perimeter edge 72 that engages with the upward edge 55 of the sidewall 54 in a closed configuration.

Embodiments of the pot 51 may include a pair of handles 68, each extending outward from the sidewall 54 of the pot 51. The handles 68 may take any appropriate size, shape, type, and/or configuration, and may be located as appropriate and/or desired for maneuverability of the cooking apparatus 50.

In this embodiment, a tube 58 may extend proximally-to-distally upward from a first end 60 through the floor 52 of the pot 51 to a second end 62 positioned at a tube height, H_{T}, above the floor 52 within the interior cooking region 56 of the pot 51. The tube 58 may from a first opening 64 at the first end 60 adjacent to the floor 52 and a second opening 66 at the second end 62, which opens into the interior cooking region 56 adjacent the upward edge 55 of the sidewall 54.

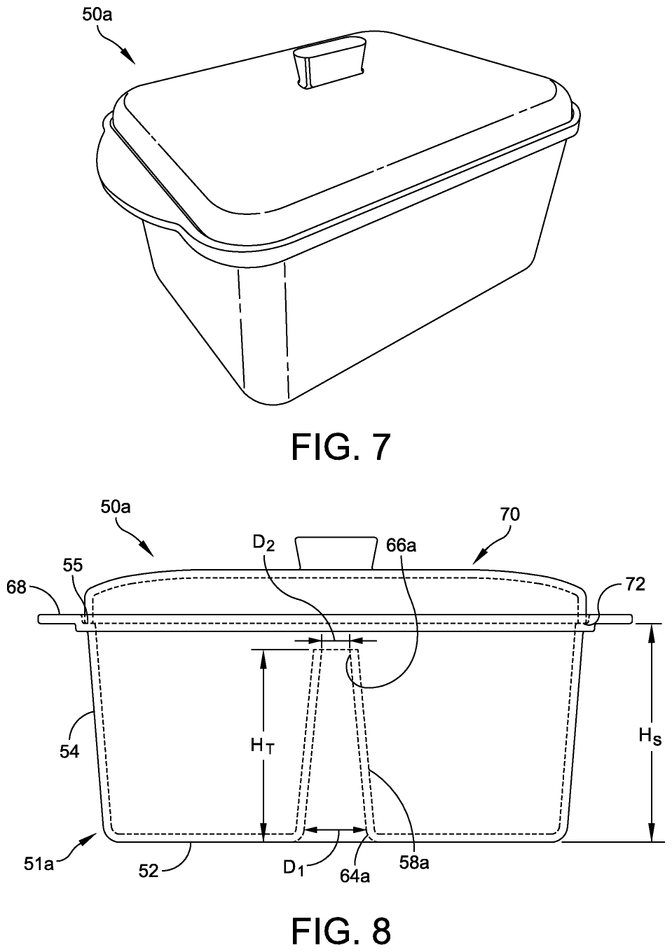

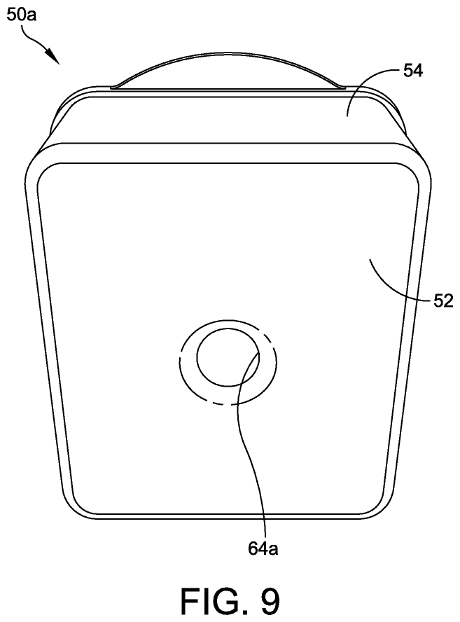

Embodiments of the tube 58 may be straight-walled or conical in shape. In this embodiment, the tube 58 comprises a straight wall in which the first opening 64 and the second opening 66 have equal diameters D₁ and D₂, respectively. In a conical version, discussed below in relation to FIGS. 7-9, the first opening of the tube may have a first diameter that is larger than a second diameter of the second opening of the tube.

In this embodiment, the tube height, H_{T}, may approximate a sidewall height, H_{S}, such that the height of the tube 58 and a location of the lid 70 above the second opening 66 of the tube 58, when the perimeter edge 72 of the lid 70 engages with the upward edge 55 of the sidewall 54, provides an airspace for a smoke passageway or pathway along arrow SP from a smoke source 80 (e.g., a fire) into the first opening 64 of the tube 58, through the second opening 66 of the tube 58, and into the interior cooking region 56.

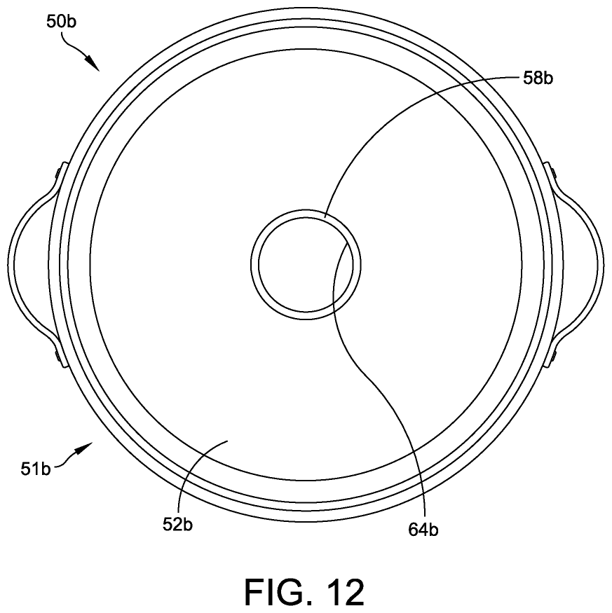

The configuration of the tube 58, which extends through the floor 52 and rises to a location near the lid 70 provides the interior cooking region 56 with a large volume in comparison to the exterior dimensions of the cooking apparatus 50. As discussed below in reference to FIGS. 7-12, the tube 68 may rise to any appropriate height that is equal to, above, or below the upward edge 55 of the sidewall 54 such that the tube height, HT, maximizes the cooking space within the interior cooking region 56 without blocking smoke into the interior cooking region 56 while directing smoke from the outside of the apparatus 50, through the tube 58, and into the interior cooking region 56 along arrow SP.

FIG. 6 illustrates a cross-sectional view detailing one embodiment of the lid 70. As shown, the lid 70 may have a domed configuration, or a domed interior potion 73, designed to provide an airspace above the second opening 66 of the tube 58 within the interior cooking region 56 when the perimeter edge 72 of the lid 70 is engaged with the upward edge 55 of the pot sidewall 54 in the closed configuration. This airspace facilitates a flow of smoke along the smoke passageway along arrow SP from the second opening 66 of the tube 58 into the interior cooking region 56.

Venting may be provided via one or more of the lid 70, the sidewall 54, or a combination of the lid 70 and the sidewall 54. Specifically, in some embodiments, the sidewall 54 and/or the lid 70 may be configured to form one or more wall vents 69 and/or lid vents 74, shown in FIGS. 4-6. Airflow may be allowed to escape from the interior cooking region 56 through these vents 69, 74. This airflow facilitates increased smoke travel or circulation from the first opening 64 of the tube 58, through the second opening 66 of the tube 58, and into the interior cooking region 56 defined by the floor 52 and the sidewall 54. This enhanced smoke circulation provides thorough flavoring to the food placed within the interior cooking region 56.

In use, smoke from the smoke source 80 travels along the smoke passageway, SP, into the first opening 64 of the tube 58, through the second opening 66 of the tube 58, and into the interior cooking region 56, where the smoke imparts a smokey flavor to the food contained within the interior cooking region 56.

In various embodiments, the sidewall 54, the floor 52, the tube 58, and the lid 70 may be formed from a single material or a combination of materials. Exemplary materials may include ceramic, glass, and/or one or more metals such as stainless steel, aluminum, copper, or cast iron.

In various embodiments, the interior cooking region 56 is configured to provide smoke to the top of a liquid 57 placed therein, as shown in FIGS. 4-5. The floor 52 and the sidewall 54 are configured to cause condensation of the steam generated from the liquid 57 and of the smoke directed to the interior cooking region 56 via the smoke passageway, SP, or in other words, to form droplets of condensation from the steam within the smoky air. This provides a combined smoke effect within the interior cooking region 56 in which the smoke provided to the top of the liquid 57 via the tube 58 may provide approximately 20-percent of the combined smoke effect within the interior cooking region 56, and the condensation of the steam and the smoke may provide approximately 80-percent of the combined smoke effect within the interior cooking region 56. A relatively high heat application to the food at the same time as the application of the smoke from the tube 58 to the interior cooking region 56 is important to create a desired flavor. The condensation of the steam and the smoke caused by the heated floor 52 and the sidewall 54 occurs at a relatively high temperature. For example, the requisite high temperature may approach, reach, or exceed the boiling point of the liquid 57, temperatures that are sufficiently high to activate the steam and create a maximum smoking effect.

In various embodiments, the pot 51 may be configured to suspend the tube 58 above the smoke source 80, which may be a fire or an open flame. In some embodiments, the cooking apparatus 50 may be configured for placement of the floor 52 of the pot 51 upon a grill so as to suspend the tube 58 above the grill's fire. In this regard, embodiments of the cooking apparatus, including the pot 51 and the lid 70, may feature a horizontal cross-section of any appropriate shape including, for example, a rectangular shape, a round shape, an oval shape, or a square shape. In some embodiments, the apparatus 50 may be configured to match the shape of a grill.

FIGS. 7-9 illustrate respective front perspective, side plan, and rear perspective views of another exemplary embodiment of a cooking apparatus 50a. The cooking apparatus 50a is similar to the apparatus 50, discussed above, and identical components are identified with identical reference numbers. Differing components are identified with the designator “a.” In this embodiment, the cooking apparatus 50a includes a conical or tapered tube 58a in which the first opening 64a of the tube 58a has a diameter, D₁, that is greater than a diameter D₂, of the second opening 66a of the tube 58a. In addition, the tube 58a has a tube height, H_{T}, that is less than the sidewall height, H_{S}, providing a larger airspace between the second opening 66a and the domed interior portion of the lid 70 when the lid 70 engages the upward edge 55 of the sidewall 54 in the closed configuration.

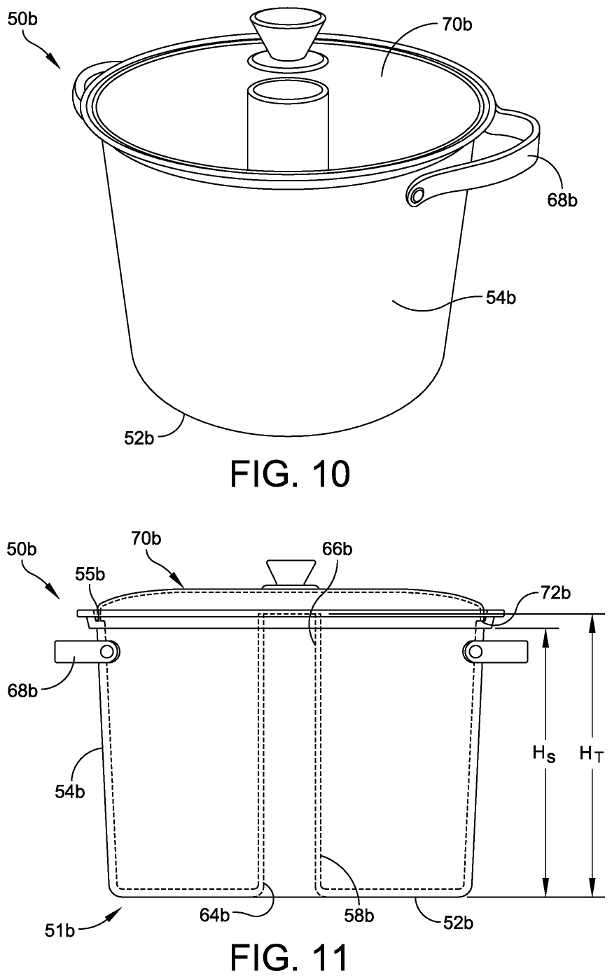

FIGS. 10-12 illustrate respective front perspective, side plan, and rear perspective views of another exemplary embodiment of a cooking apparatus 50b. The apparatus 50b is similar to the apparatus 50, discussed above, and identical components are identified with identical reference numbers. Differing components are identified with the designator “b.” In this embodiment, the apparatus 50b features a circular configuration having a circular floor 52b, sidewall 54b, and lid 70b. In addition, the tube 58b has a tube height, H_{T}, that is slightly greater than the sidewall height, H_{S}, while still providing an airspace between the second opening 66b and the interior domed portion of the lid 70b when the lid 70b engages with the upward edge 55b of the sidewall 54b in the closed configuration. Notably, the floor, sidewall, tube, and lid may each have any appropriate size, shape, and/or configuration such that their combination provides the requisite smoke pathway or passageway along arrow SP from the smoke source to the interior cooking region for the desired smoking effect.

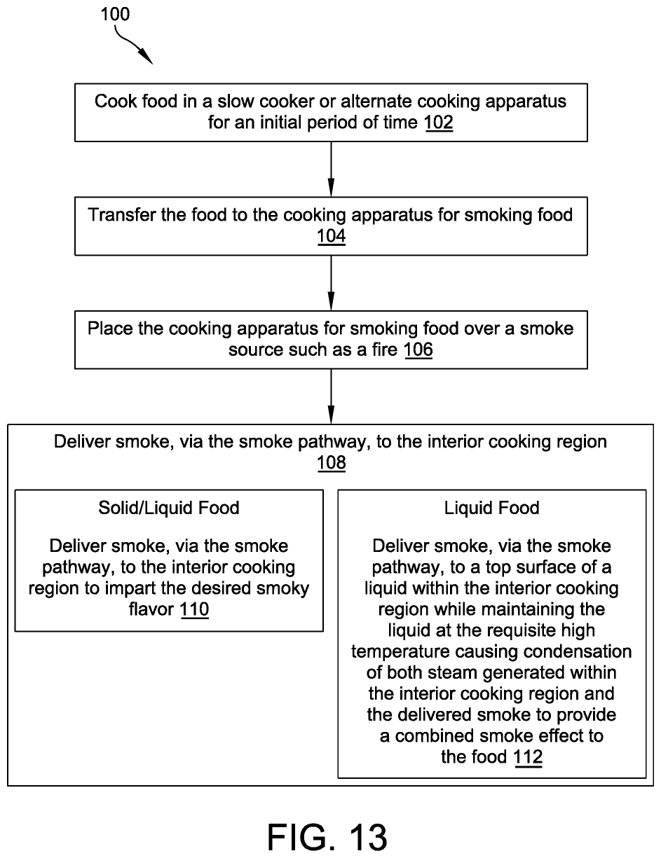

FIG. 13 provides a flowchart depicting an exemplary method (100) of cooking food using an embodiment of the cooking apparatus for smoking food 50, 50a, 50b, discussed above. In this embodiment, the method (100) initiates with cooking food in a slow cooker (e.g., a Crock-Pot), a stew pot, or another cooking apparatus for an initial period of time (102). After the initial period of time, the partially-cooked or fully-cooked food (e.g., solid or liquid food) may be moved or transferred from the slow cooker or the other cooking apparatus to an embodiment of the cooking apparatus for smoking food 50, 50a, 50b disclosed herein (104) and placed over the smoke source 80 (106) such as, for example, a fire, a grill, and so on.

Using this method, food may be partially or fully cooked (102) before being transferred to an embodiment of the smoking device 50, 50a, 50b (104) for delivery of smoke to the interior cooking region 56 (108). In one instance pertaining to liquid or solid food, the smoke may be delivered while the apparatus 50, 50a, 50b and/or the food is maintained at any appropriate temperature to impart a desired smoky flavor to the food (110). Alternatively, and in the instance of liquid food 57 within the cooking apparatus 50, 50a, 50b, the tube 58 may deliver smoke along the smoke passageway or pathway, SP, to the top of the liquid 57 within the interior cooking region 56, while the heated floor 52 and the sidewall 54 of the pot 51, 51a, 51b maintain the liquid 57 at the requisite high temperature (e.g., approaching, reaching, or exceeding the boiling point of the liquid 57) to cause condensation of both the steam generated within the interior cooking region 56 and the smoke delivered into the interior cooking region 56, so as to provide a combined smoke effect within the interior cooking region 56 (112), as discussed above.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A cooking apparatus for smoking food, the cooking apparatus comprising:
a pot having a floor, a sidewall extending upwardly from the floor to an upward edge, an interior cooking region formed within the sidewall and above the floor, and a tube extending through the floor of the pot into the interior cooking region, the tube forming a first opening adjacent the floor, a second opening adjacent the upward edge, and a height from the first opening to the second opening; and
a lid having a perimeter edge to engage the upward edge of the pot;
wherein the height of the tube and a location of the lid above the tube when the perimeter edge is engaged with the upward edge of the pot provides a smoke passageway from the first opening, through the second opening, and into the interior cooking region.

2. The cooking apparatus of claim 1, wherein the lid features a domed configuration that provides an airspace above the second opening of the tube when the perimeter edge of the lid engages the upward edge of the pot.

3. The cooking apparatus of claim 1, wherein one or both of the sidewall and the lid form one or more vents to allow airflow from the interior cooking region so as to facilitate increased smoke travel from the first opening of the tube, through the second opening of the tube, and into the interior cooking region.

4. The cooking apparatus of claim 1, wherein the sidewall, the floor, and the tube are formed from a single material.

5. The cooking apparatus of claim 4, wherein the material is cast iron, ceramic, glass, copper, aluminum, or stainless steel.

6. The cooking apparatus of claim 1, wherein the tube is straight walled so as to provide the first opening with a first diameter that is equal to a second diameter of the second opening.

7. The cooking apparatus of claim 1, wherein the tube is conical so as to provide the first opening with a first diameter that is greater than a diameter of the second opening.

8. The cooking apparatus of claim 1, wherein:
the height of the tube maximizes a cooking space within the interior cooking region and is less than, equal to, or greater than a height of the sidewall; and
the second opening located at the height of the tube is lower than the lid so as to not block smoke into the interior cooking region.

9. The cooking apparatus of claim 1, wherein the interior cooking region is configured to provide smoke to a top of a liquid therein, and the floor and the sidewall are configured to cause condensation of steam generated from the liquid and of the smoke so as to provide a combined smoke effect within the interior cooking region.

10. The cooking apparatus of claim 9, wherein the smoke provided to the top of the liquid provides approximately 20-percent of the combined smoke effect within the interior cooking region, and the condensation of the steam and the smoke provides approximately 80-percent of the combined smoke effect within the interior cooking region.

11. The cooking apparatus of claim 1, wherein the pot is configured to suspend the tube above a fire.

12. A cooking device for smoking food, comprising:
a pot, comprising:
a floor;
a sidewall extending proximally-to-distally from the floor to an upward edge such that an interior cooking region is formed within the sidewall and above the floor; and
a tube extending proximally-to-distally from a first opening formed in the floor to a second opening formed adjacent to the upward edge of the sidewall; and
a lid having a domed interior portion that terminates in a perimeter edge,
wherein engaging the perimeter edge with the upward edge of the pot forms a smoke pathway from the first opening, through the second opening, and into the interior cooking region.

13. The cooking device of claim 12, wherein the first opening has a first diameter, the second opening has a second diameter, and the first and the second diameters are equal.

14. The cooking device of claim 12, wherein the first opening has a first diameter, the second opening has a second diameter, and the first diameter is greater than the second diameter.

15. The cooking device of claim 12, wherein when the perimeter edge of the lid is engaged with the upward edge of the pot, the domed interior portion of the lid is offset from the second opening of the tube, thereby providing an airspace above the second opening of the tube for the smoke pathway into the interior cooking region.

16. The cooking device of claim 12, wherein at least one of the sidewall and the lid include one or more vents to allow airflow from the interior cooking region that facilitates smoke travel from the first opening of the tube, through the second opening of the tube, and into the interior cooking region along the smoke pathway.

17. The cooking device of claim 12, wherein when the smoke pathway provides smoke to a surface of a liquid within the interior cooking region, the floor and the sidewall cause condensation of steam generated from the liquid and of the smoke so as to provide a combined smoke effect within the interior cooking region.

18. A method of smoking food with a smoking pot apparatus, the method comprising:
cooking food in a first cooking apparatus for an initial period of time; and
after the initial period of time, moving the food from the first cooking apparatus to the smoking pot apparatus, the smoking pot apparatus comprising:
a pot having a floor, a sidewall extending upwardly from the floor to an upward edge, an interior cooking region formed within the sidewall and above the floor, and a tube extending through the floor into the interior cooking region, the tube having a first opening adjacent the floor, a second opening adjacent the upward edge, and a height from the first opening to the second opening; and
a lid having a domed interior portion extending to a perimeter edge that engages with the upward edge of the sidewall of the pot;
wherein the height of the tube and the location of the domed interior portion of the lid above the second opening of the tube when the perimeter edge of the lid is engaged with the upward edge of the pot provides a smoke pathway from the first opening, through the second opening, and into the interior cooking region.

19. The method of claim 18, wherein the first cooking apparatus comprises a slow cooker.

20. The method of claim 18, wherein the food comprises a liquid, the method further comprising:
maintaining the liquid at a cooking temperature sufficient to generate and condense steam within the interior cooking region; and
delivering smoke, via the smoke pathway, from a smoke source positioned below the smoking pot apparatus to a top surface of the liquid, thereby causing condensation of the steam and the smoke to provide a combined smoke effect within the interior cooking region.
